(19) United States
(12) Patent Application Publication
(10) Pub. No.: US 2016/0364851 A1
(43) Pub. Date: Dec. 15, 2016

(54) DEFECT INSPECTION METHOD AND APPARATUS

(71) Applicant: Hitachi, Ltd., Tokyo (JP)

(72) Inventors: Takaaki KONISHI, Tokyo (JP); Hiroyuki NAKANO, Tokyo (JP)

(21) Appl. No.: 15/098,525

(22) Filed: Apr. 14, 2016

(30) Foreign Application Priority Data
Jun. 10, 2015 (JP) 2015-117115

(51) Int. Cl. G06T 7/00; G01N 21/88; G01N 21/954; G06T 7/20

(52) U.S. Cl. CPC G06T 7/0004; G06T 7/0051; G06T 7/20; G06T 7/004; G01N 21/8851; G01N 21/954; G06T 2207/30108

(57) ABSTRACT

A defect inspection apparatus is provided which is configured of an image capturing machine which performs image capturing of a surface of a structure by moving along the surface of the structure; a light projection device which radiates light to an image capturing region of the image capturing machine; a first control unit which controls a lens position of the image capturing machine by using a distance to the surface of the structure which is obtained from an image capturing position of light captured in the image capturing machine; and a second control unit which controls a transmission speed of a driving charge of the image capturing machine by using a movement speed relative to the structure which is obtained from a frequency of the light captured in the image capturing machine.

### TECHNICAL FIELD

The present invention is related to a method and an apparatus for inspecting a defect on the surface of a structure.

### BACKGROUND ART

In recent years, in a structure as social infrastructure such as a tunnel, less durability due to deterioration becomes a social problem, and it is more necessary to perform a regular inspection and repair work for maintenance. In a regular inspection in the related art, a proximity visual inspection or a hammering test has been performed; however, since it is a manual work, it is inefficient, and it takes several hours in a total inspection. For this reason, it is difficult to perform an inspection in a structure in service, and it is necessary to perform an inspection in a time zone in which the structure is not in service, or perform an inspection by temporarily stopping the service, and accordingly, there has been a problem of a low frequency in inspection, or a low operation rate of the structure.

Therefore, an inspection method of using a camera mounted on a travelling vehicle has been proposed. For example, as an apparatus which performs an inspection by capturing an image of a tunnel wall face, there is PTL 1. In PTL 1, an apparatus which obtains a developed image of a tunnel wall face by performing sectional scanning in a direction orthogonal to a traveling direction with respect to the tunnel wall face, and sequentially accumulating data, by using one-dimensional sensor camera which is mounted on a travelling vehicle in the tunnel has been disclosed.

In addition, as a camera which corresponds to a high speed movement of an inspection target, there is a Time Delay Integration (TDI) camera. FIG. 1 schematically illustrates the entire structure of the TDI camera, and FIG. 2 illustrates a structure which is viewed in a vertical viewing direction. A TDI camera 1 condenses light which is scattered from a measuring point 2 on the surface of an inspection target on a light receiving element 4 through a lens 3, and transmits the light to an adjacent light receiving element when reading a charge which is photo-electrically converted in the light receiving element 4. At this time, it is possible to accumulate charges by the number of transmission times, by matching a relative movement speed between the TDI camera 1 and an inspection target and a transmission timing of charges of the light receiving element 4. In this manner, it is possible to capture a high S/N image by lengthening an exposure time by using the TDI camera, with respect to the inspection target which moves at high speed, and of which an exposure time for image capturing becomes short when using a normal camera.

As a method for inspecting an inspection target which moves at high speed using a TDI camera, for example, there is PTL 2. In PTL 2, a method has been disclosed, in which it is possible to avoid blurring of an image by correcting a charge addition variation, and perform a high speed inspection when a stage is scanned at a speed higher than a line rate (charge transmission speed) of the TDI camera, in a surface inspection in which a semiconductor wafer, or the like, is set to a target.

### CITATION LIST

### Patent Literature

PTL 1: JP-A-06-042300

PTL 2: JP-A-2010-256340

### SUMMARY OF INVENTION

### Technical Problem

However, in the method which is described in PTL 1, a configuration in which image contrast which decreases according to a decrease in accumulation time which accompanies an increase in speed is emphasized is not included, and it is difficult to correspond to high speed. In addition, a configuration of avoiding blurring of an image which occurs due to a change in image capturing distance which is caused by a vibration of a train is not described. In addition, in the method which is described in PTL 2, a controlling method of a speed ratio in a system in which a speed relative to an inspection target is known, and a correcting method thereof are described; however, a case in which a speed relative to an inspection target is not known is not described. In addition, a configuration of avoiding blurring of an image which occurs due to a change in image capturing distance is also not described.

Therefore, the invention has been made in consideration of such a situation, and an object thereof is to provide a defect inspection method and a defect inspection apparatus in which it is possible to perform an inspection of a defect on the surface of a structure in which a speed relative to an inspection apparatus, and a distance from the inspection apparatus are changed, at high speed and with high accuracy.

### Solution to Problem

In order to solve the above described problem, the invention includes an image capturing machine which performs image capturing of a surface of a structure by moving along the surface of the structure; a light projection device which radiates light to an image capturing region of the image capturing machine; a first control unit which controls a lens position of the image capturing machine by using a distance to the surface of the structure which is obtained from an image capturing position of light captured in the image capturing machine; and a second control unit which controls a transmission speed of a driving charge of the image capturing machine by using a movement speed relative to the structure which is obtained from a frequency of the light captured in the image capturing machine.

### Advantageous Effects of Invention

According to the invention, it is possible to perform an inspection of a defect on the surface of a structure in which a speed relative to an inspection apparatus, and a distance from the inspection apparatus are changed at high speed and with high accuracy.

### BRIEF DESCRIPTION OF DRAWINGS

FIG. 1 is a diagram which illustrates an example of a structure of a TDI camera.

FIG. 2 is a diagram which describes a principle of image capturing of the TDI camera.

FIG. 3 is a diagram which schematically describes the entire configuration of a surface inspection apparatus according to an embodiment 1 along with a structure as an inspection target.

FIG. 4 is a flowchart which illustrates a detail of each function in the surface inspection apparatus according to the embodiment 1.

FIG. 5 is a diagram which illustrates a schematic configuration of an image capturing apparatus and a light projection device.

FIG. 6 is a diagram which illustrates a relationship between a light radiating position of the light projection device and condensing of the image capturing apparatus.

FIG. 7 is a diagram which illustrates an example of a captured image in a case in which a distance to an image capturing target is constant.

FIG. 8 is a diagram which illustrates a relationship between a light radiating position of the light projection device and condensing of the image capturing apparatus in a case in which a distance to an image capturing target is changed.

FIG. 9 is a diagram which illustrates an example of a captured image in a case in which a distance to an image capturing target is changed.

FIG. 10 is a diagram which illustrates an example of an image in which an emission line of a captured image is extracted.

FIG. 11 is a diagram which illustrates an example of an image in which a center line of an emission line of a captured image is extracted.

FIG. 12 is a diagram which illustrates a fluctuating parameter at a center line position of a captured image.

FIG. 13 is a diagram which illustrates each fluctuating parameter in a case in which a distance to an image capturing target is changed.

FIG. 14 is a diagram which illustrates an example of a lens control position in a case in which a distance to an image capturing target is changed.

FIG. 15 is a diagram which illustrates an example of a captured image in a case in which a lens control is performed in a case in which a distance to an image capturing target is changed.

FIG. 16 is a diagram which illustrates a relationship between a light radiating position of the light projection device and condensing of the image capturing apparatus.

FIG. 17 is a graph which illustrates an example of a change in light intensity which is measured in a captured image in a case in which an image capturing target is moving.

FIG. 18 is a graph which illustrates an example of a frequency distribution in a change in light intensity which is measured in a captured image in a case in which an image capturing target is moving.

FIG. 19 is a graph which illustrates an example of a change in light intensity which is measured in a captured image in a case in which a movement speed of an image capturing target is changed.

FIG. 20 is a graph which illustrates an example of a frequency distribution in a change in light intensity which is measured in a captured image in a case in which a movement speed of an image capturing target is changed.

FIG. 21 is a diagram which illustrates a relationship between a light radiating position of a light projection device and condensing of an image capturing apparatus according to another configuration.

FIG. 22 is a diagram which illustrates a change in size of a visual field in a case in which a distance to an image capturing target is changed.

FIG. 23 is a diagram which illustrates a digital zooming range of a captured image.

FIG. 24 is a diagram which illustrates an image which is obtained by performing digital zooming processing in a captured image.

FIG. 25 is a diagram which illustrates an image obtained by extracting a defective region from an image in which digital zooming processing is performed.

FIG. 26 is a diagram which illustrates a schematic configuration of an image capturing apparatus and a light projection device according to another configuration.

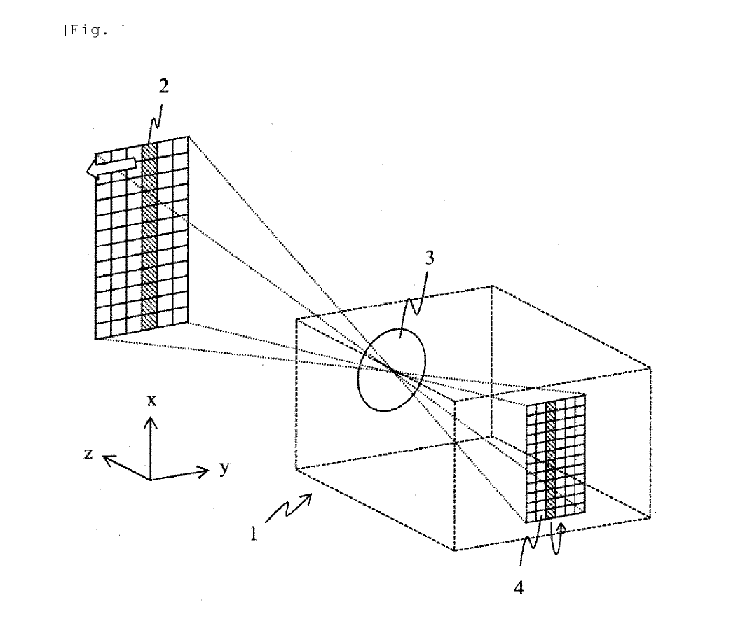

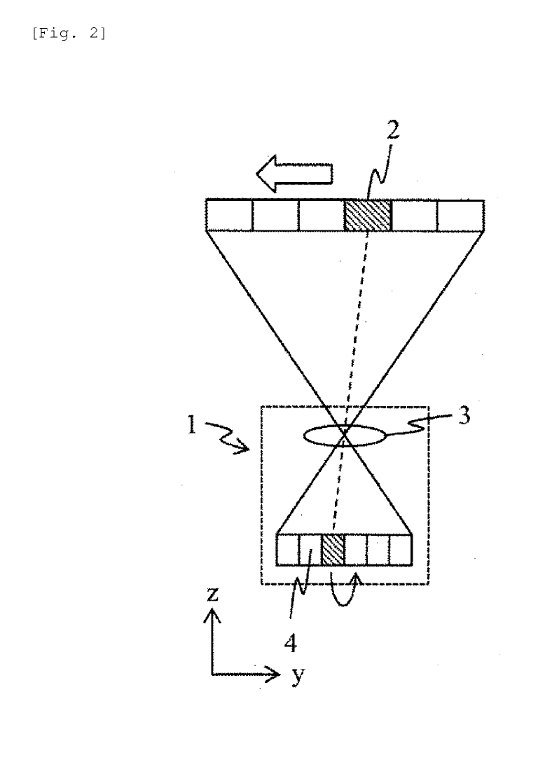

### DESCRIPTION OF EMBODIMENTS

Hereinafter, an embodiment will be described by using drawings. In addition, the following descriptions are merely an embodiment, and it is needless to say that contents of the invention are not limited to the following form.

### Embodiment 1

An outline of an inspection using an apparatus will be described by using FIGS. 3 to 26.

FIG. 3 schematically illustrates an apparatus for performing an inspection in the embodiment. The apparatus is provided with a TDI camera 1 which captures an image of the surface of a structure 5 as an inspection target, and a light projection device 8 which radiates light beams 7A and 7B toward an image capturing region 6 of the TDI camera 1. In addition, an image processing unit 9 which processes an image which is sent from the TDI camera 1, a control unit 10 which controls the TDI camera 1 by using a result of the image processing unit 9, a display unit 11 which displays a processing result in the image processing unit, and a storage unit 12 which stores the processing result are provided in the apparatus.

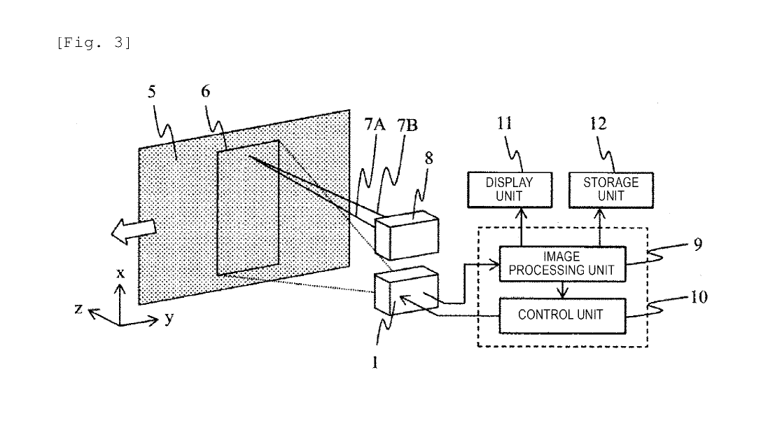

FIG. 4 is a block diagram of a structure inspection process which includes an inspection method in the embodiment. When an inspection is started in S101, the inspection apparatus is operated in S102, and image capturing of the surface of a structure 5 as an inspection target is performed in S103. In the captured image, an emission line of light which is radiated from the light projection device 8, in the image, is extracted in S104. In S105, distance data 106 from the TDI camera 1 of the inspection apparatus to the surface of the structure 5, and movement speed data 107 of the inspection apparatus relative to the structure 5 are calculated in S105 by using a position of an emission line of light which is extracted, a width of the emission line, and information of luminance changing frequency. Whether or not the distance data 106 matches the current setting of a focal distance of the TDI camera 1 is determined in S108, the data is left at that in a case of matching, and a control of a lens position is performed in S109 in a case of mismatching. Subsequently, whether or not the speed data 107 matches the current charge transmission speed of the TDI camera 1 is determined in S110, the data is left at that in a case of matching, and a control of a charge transmission speed of the camera is performed in S111 in a case of mismatching. In addition, at the same time as extracting of the emission line in S104, a change in size of a visual field of a captured image is corrected in S112, a defect in the image is extracted in S113, the captured image is displayed on the display unit 11, and detect data is stored in the storage unit 12 in S114. Thereafter, whether or not image capturing in the entire inspection target region is completed is determined in S115, the process returns to S102 in a case in which image capturing is not completed, and image capturing is continued by moving an inspection target region. In a case in which the entire image capturing process is completed, the process proceeds to S116, and inspections are completed. Hereinafter, a detail in each step will be individually described.

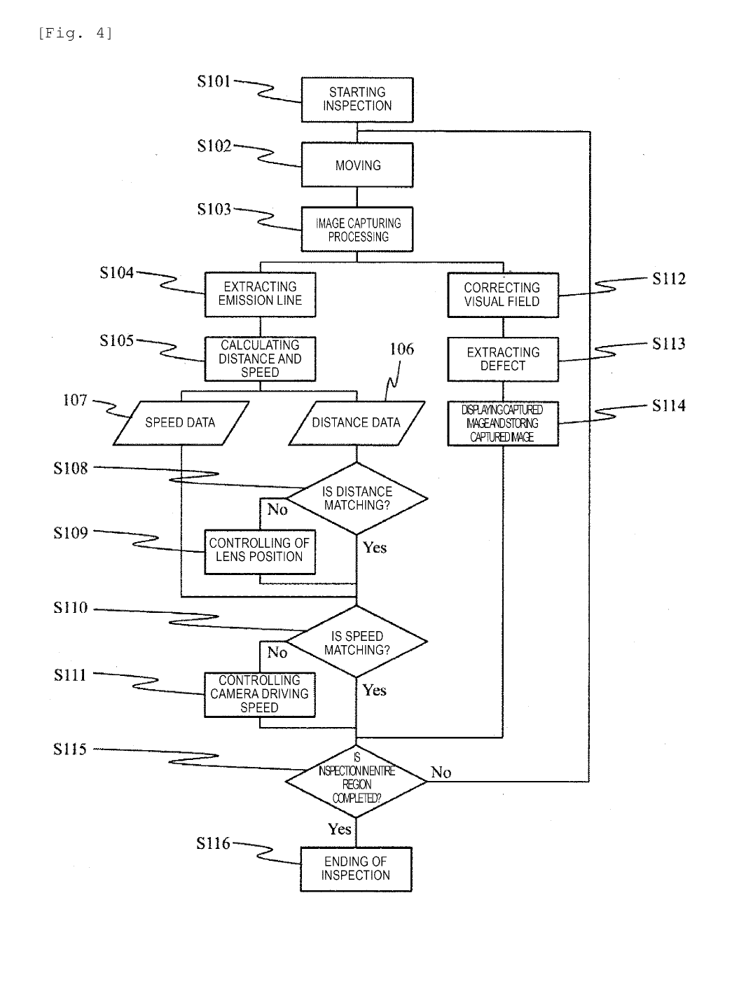

First, a method in which a distance is calculated from a captured image, and a lens position is controlled will be described using FIGS. 5 to 18.

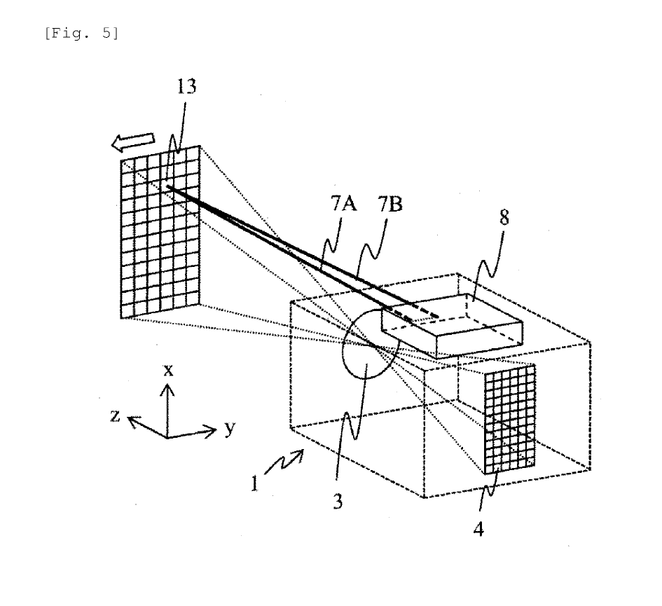

FIG. 5 illustrates appearances of the TDI camera 1 and the light projection device 8, and FIG. 6 illustrates a diagram for describing an imaging relation between the TDI camera 1 and the surface of an image capturing target. Two light beams of 7A and 7B are radiated from the light projection device 8 toward the surface of an image capturing target. The light beams of 7A and 7B are arranged in parallel to a y axis in a relative movement direction between the TDI camera 1 and the image capturing target, and light beams are radiated toward a radiating point 13 on the surface of the image capturing target. In addition, the radiating direction of the light beams of 7A and 7B is set so that the light beams are radiated to one point of the radiating point 13 in a distance to an image capturing target which is arbitrarily set. In addition, an angle of the light beams of 7A and 7B is set in a range in which a radiating point is viewed as one point, in a fluctuation range of a distance to an image capturing target. The radiating point 13 on the surface of the image capturing target is condensed on the light receiving element 4 through the lens 3 of the TDI camera 1, and is measured as a point having high luminance compared to a region other than the radiating point 13, on the captured image. FIG. 7 illustrates an example of a captured image of the TDI camera 1 in a case in which a distance between the TDI camera 1 and the surface of an inspection target is constant. In addition, the captured image is in inverted relation with an image capturing target through a lens, and is reversed vertically and horizontally; however, for ease of descriptions, hereinafter, the captured image will be displayed and described as an image which is projected onto the surface of the image capturing target by reversing an x axis and the y axis so that the captured image is in the erecting direction with respect to the image capturing target. In addition, in a captured image which is used when explaining a calculation method of a distance, a display of a crack of an inspection target, or the like, which is originally captured, and is not related with a distance calculation will be omitted. The TDI camera 1 and the image capturing target relatively move in the y axis direction in FIG. 5, and since charge transmission is performed in the y axis direction in the TDI camera 1, a captured image 14 becomes a continuous image with a length corresponding to a movement distance in the y axis direction. A point with high luminance which is condensed from the radiating point 13 appears as an emission line 15, and has a length in the y axis direction so as to correspond to the movement direction. In a case in which a distance between the TDI camera 1 and an image capturing target is constant, the emission line 15 on the captured image has the x-coordinate which is constant, and a width of the emission line becomes also constant since imaging relation is also not changed. In addition, in the light projection device 8, another means in which there is no limit in intensity, and which can obtain the same effect may be adopted when they are means which uses laser, or the like, and radiates coherent light to be used in a speed measurement which will be described later.

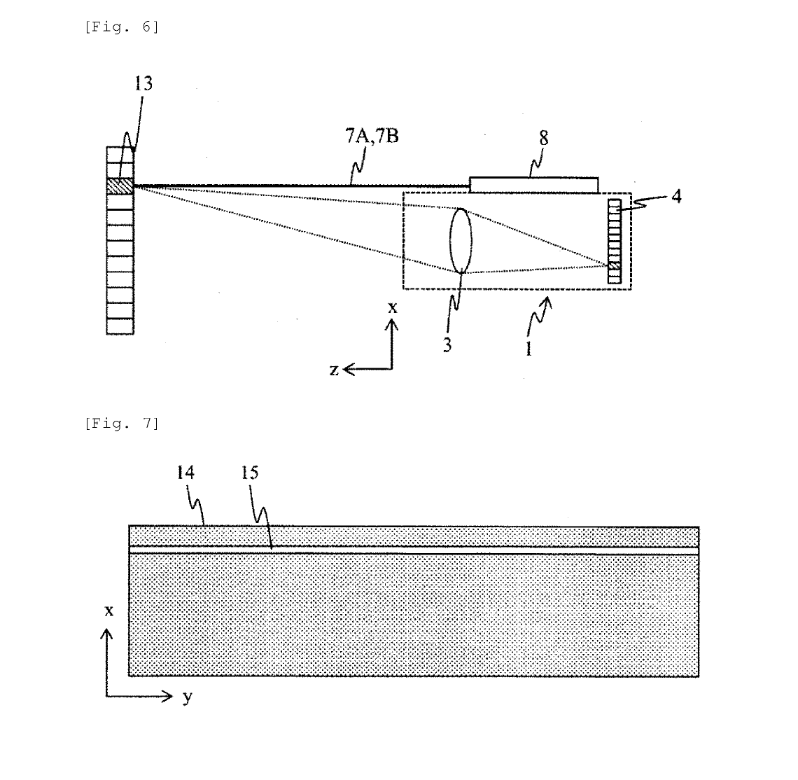

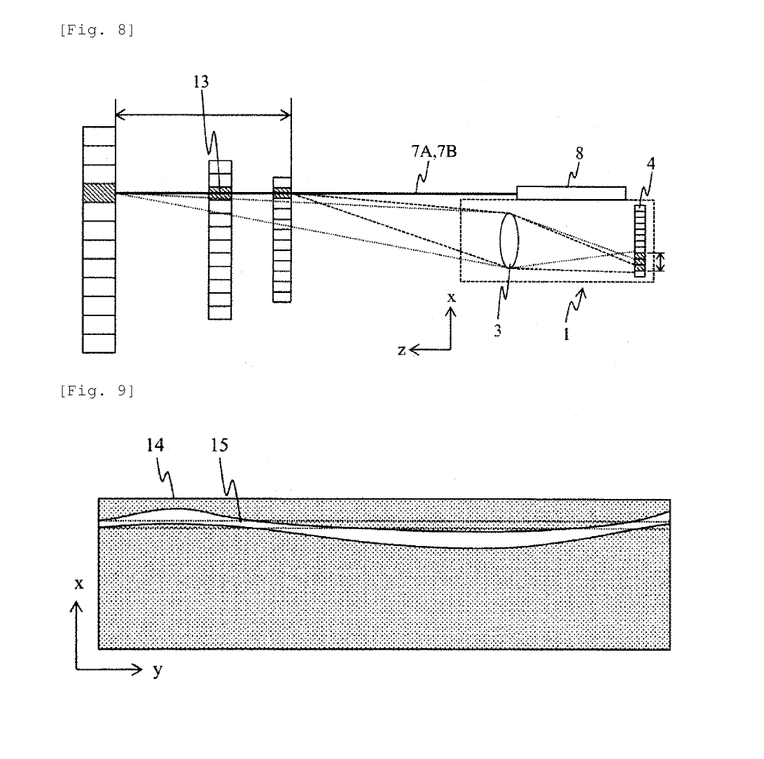

FIG. 8 illustrates a diagram which describes an imaging relation between the TDI camera 1 and the surface of an image capturing target in a case in which a distance from the surface of the image capturing target is changed. In addition, FIG. 9 illustrates an example of a captured image of the TDI camera 1 in a case in which a distance is changed. In a case in which a distance is changed in a state in which a lens position is fixed, an imaging relation illustrated in FIG. 6 is lost, and a condensing position of the radiating point 13 on the light receiving element 4 is shifted. As a result, blurring occurs on the captured image 14 along with a change in distance, that is, the width of the emission line 15 on the captured image 14 becomes thick. At this time, blurring occurs in both cases of a short distance and a long distance, and the emission line 15 becomes thick, definitely, in a case in which the imaging relation is lost. In addition, since a lens magnification is also changed in a case in which a distance is changed in a state in which a lens position is fixed, a condensed pixel position of the radiating point 13 which is irradiated with the light beams of 7A and 7B is changed in the x axis direction on the light receiving element 4. For this reason, the center x-coordinate of the emission line 15 on the captured image 14 is changed along with a change in distance. At this time, in a case in which the distance becomes short, the x-coordinate moves in the positive x axis direction in FIG. 9, and in a case in which the distance becomes long, the x-coordinate moves in the negative x axis direction. That is, in a case in which the distance is changed, as illustrated in FIG. 9, as the captured image, a captured image in which the center coordinate and the width of the emission line 15 are changed is obtained, and a direction in which the distance is changed and an absolute distance are uniquely obtained from the center coordinate of the emission line 15.

A detailed process of the above described distance calculation method will be described by using FIGS. 9 to 13.

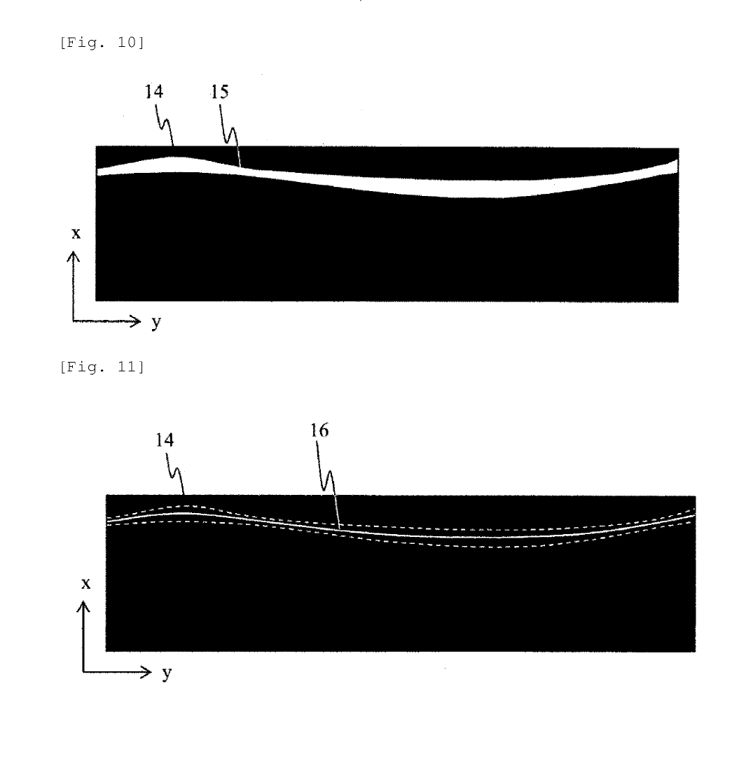

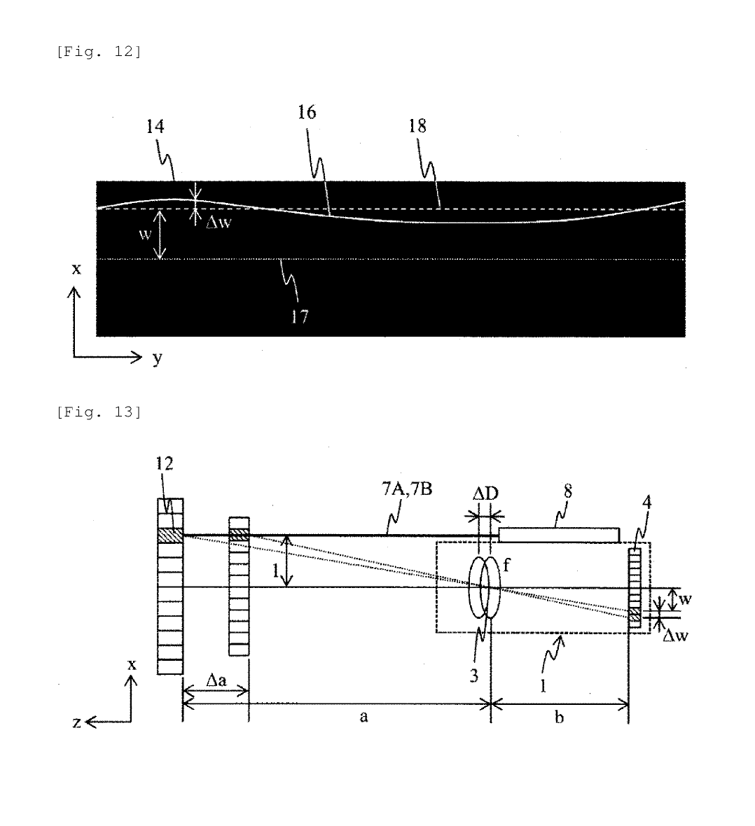

First, an emission line is extracted from a captured image in step S104 in FIG. 4. Light from the radiating point 13 is brightly captured compared to other regions on the captured image 14. Therefore, as illustrated in FIG. 10, the emission line 15 is extracted by using image processing such as binarization processing of luminance, for example. Subsequently, a center line 16 of the emission line 15 is extracted from a region of the extracted emission line 15, as illustrated in FIG. 11, by performing image processing such as thinning processing, for example. As illustrated in FIG. 12, a distance w from a center axis to a reference position is obtained from a center axis 17 as a center of the captured image 14 in the x axis direction, a reference position 18 as a center position of the emission line at a time of distance matching, and the center line 16 as a center of the emission line when there is a change in distance, and a distance Δw of a center line when there is a change in distance is obtained from the reference position. Subsequently, a change in distance Δa from the change in distance Δw of the center line of the emission line of an image to an image capturing target is obtained. FIG. 13 illustrates a diagram for describing an imaging relation between the TDI camera 1 and the surface of the image capturing target. Here, a distance between the lens 3 and an image capturing target before changing a distance is set to a, an amount of change in distance of the image capturing target is set to Δa, a distance from the lens 3 to the light receiving element 4 is set to b, a distance between the center axis of the TDI camera 1 and the light beams of 7A and 7B is set to 1, a distance from the center axis of the TDI camera 1 to a light receiving position of the radiating point 13 before changing a distance is set to w, and a change in light receiving position of the emission line in the captured image due to a change in distance is set to Δw. In addition, w and Δw are set to the same distances as those which are obtained in FIG. 12. Each distance is denoted by the following relational expression (1).

1/(a−Δa)=(w+Δw)/b (1)

Accordingly, a change in distance to the image capturing target is calculated as

Δa=a−1×b/(w+Δw) (2)

In this manner, the distance Δa from the center line of the emission line Δw of an image to the image capturing target is obtained. Δa is stored in the distance data 106, is sent to the step of distance matching in S108 in FIG. 4, and in a case of distance mismatching, that is, in a case in which Δa is not zero, a control of a lens position is performed in S109.

Subsequently, a method of controlling a lens position from an amount of change in distance which is obtained will be described by using FIG. 13.

In step of distance matching S108 in FIG. 4, when it is determined that a distance is not matching, a position of the lens 3 is controlled so that an imaging relation is held by causing the distance to be matched in S109. At this time, when a focal distance of the lens 3 is set to f, an imaging relation before changing a distance is denoted by the following expression (3), by using a distance a between the lens 3 and the image capturing target, and a distance b from the lens 3 to the light receiving element 4.

1/a+1/b=1/f (3)

Here, in a case in which there is a change in distance of Δa, when a movement distance of the lens 3 which is controlled so as to hold the imaging relation is set to ΔD, a relational expression of imaging is denoted by the expression (4).

1/(a−Δa−ΔD)+1/(b+ΔD)=1/f (4)

In this manner, the lens movement distance ΔD is denoted as functions of the distance a between the lens 3 and the image capturing target before changing the distance, the distance b from the lens 3 to the light receiving element 4, the focal distance f of the lens 3, and the amount of change in distance Δa of the image capturing target, and the lens control position is uniquely obtained.

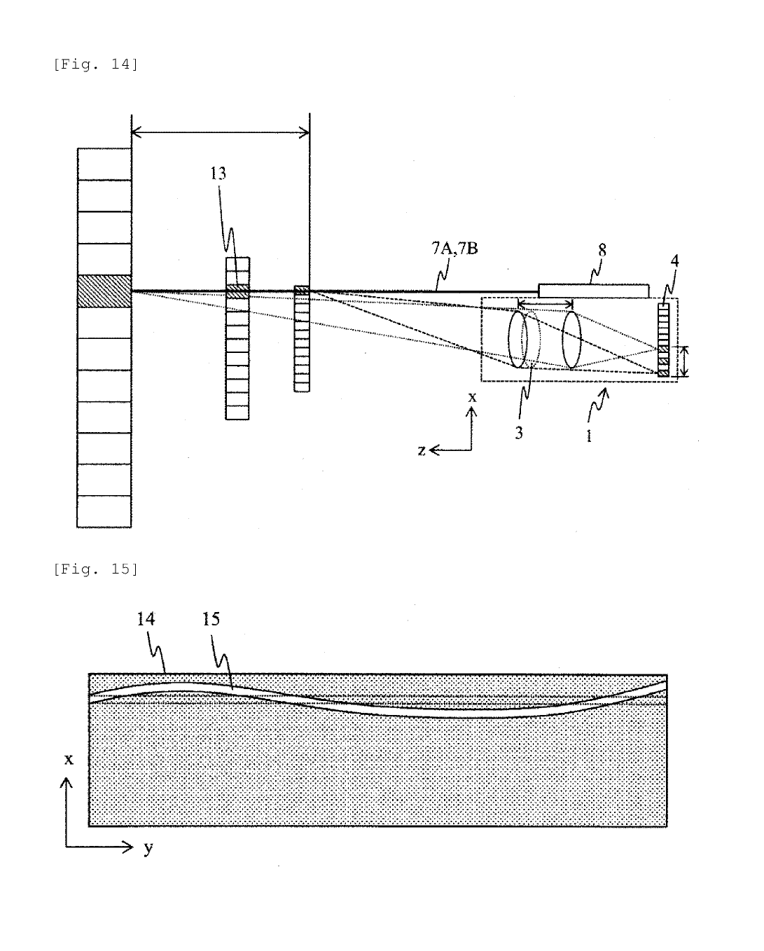

It is possible to obtain an image which is focused at all times with respect to a change in distance, as illustrated in FIG. 14, by physically controlling a position of the lens 3 of the TDI camera 1 in the axial direction based on the lens movement distance ΔD which is obtained in this manner. At this time, the captured image becomes the image in FIG. 15, and a position of the emission line 15 in the x axis direction is changed due to a change in distance; however, there is no blurring which is caused when the imaging relation is lost, and the width of the emission line 15 becomes constant.

By adopting the above described method, it is possible to obtain a distance of the TDI camera 1 from a captured image, and to control a lens position so as to obtain a focused image at all times with respect to a change in distance.

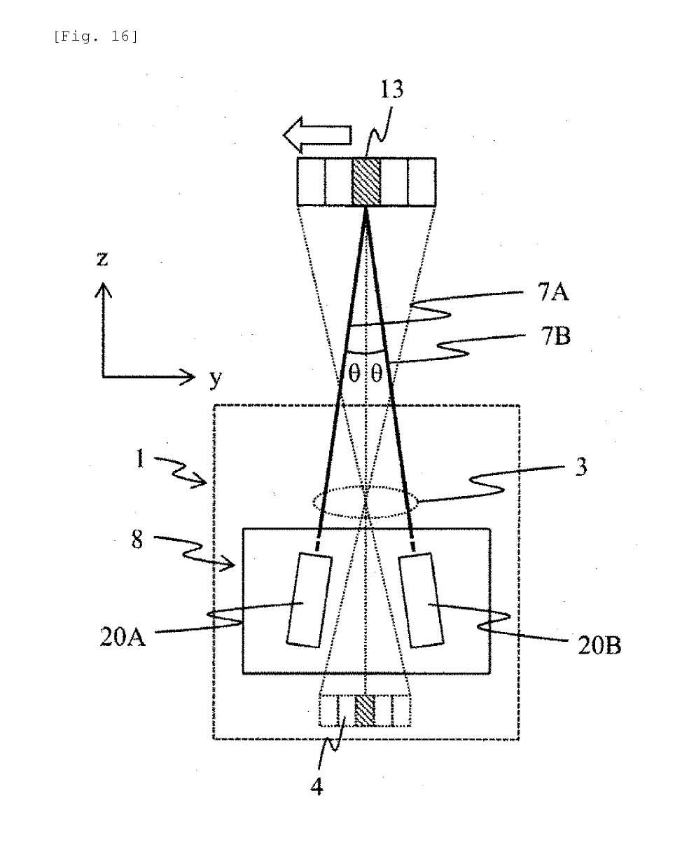

Subsequently, a method of calculating a relative movement speed from a captured image, and controlling a driving speed of the TDI camera will be described by using FIGS. 16 to 21.

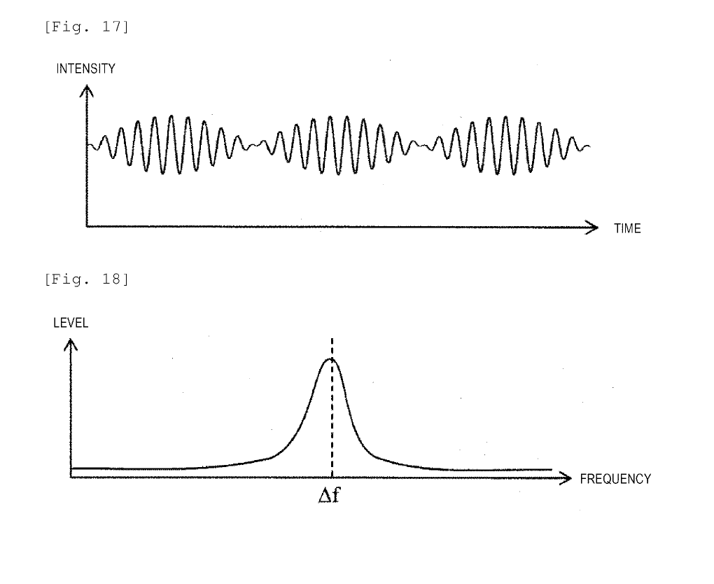

FIG. 16 illustrates appearances of the TDI camera 1 and the light projection device 8. Two light beams of 7A and 7B are radiated toward the radiating point 13 on the surface of an image capturing target from lasers 20A and 20B in the light projection device 8. The lasers 20A and 20B, and the light beams of 7A and 7B are symmetrically arranged with respect to the z axis in the image-capturing axis direction of the TDI camera 1 at an inclining angle of θ. At this time, for example, when a frequency of the laser 20A is set to F1, and a frequency of the laser 20B is set to F2 (=F1+Δf), an interference occurs in the radiating point 13. For this reason, composite vibration with light intensity which is illustrated in FIG. 17 occurs in the light receiving element 4 which condenses light from the radiating point 13. In a case in which an image capturing target is stopped, a frequency of composite vibration becomes Δf which is a difference in frequency of two lasers. FIG. 18 illustrates a result which is obtained by performing FFT processing with respect to a light intensity change signal which is detected in the light receiving element 4. The frequency becomes a maximum level in Δf which is a frequency of the composite vibration. Subsequently, a case in which a speed of an image capturing target is vo, and the image capturing target is moving from right to left in FIG. 16 will be taken into consideration. At this time, frequencies of the light beams of 7A and 7B in the radiating point 13 are changed according to the speed vo of the image capturing target due to Doppler effect. Respective frequencies after changing are denoted by the following expressions by setting a wavelength of a laser to λ, and an inclination to an image capturing axis of light beams to θ.

F1′=F1+vo/(λ×sin θ) (5)

F2′=F2−vo/(λ×sin θ) (6)

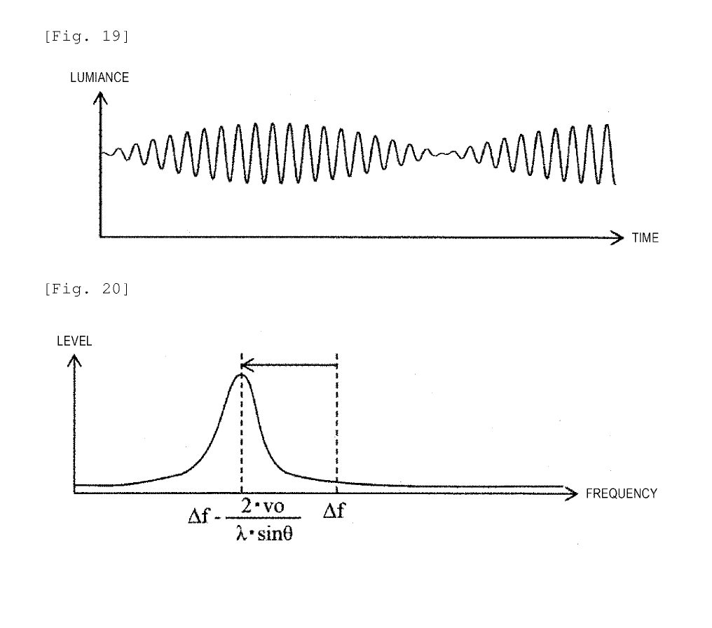

As illustrated in FIG. 19, in the light intensity in the light receiving element 4 at this time, the frequency of the composite vibration is changed. The frequency of the composite vibration at this time is denoted by the following expression.

F2′−F1′=Δf−2×vo/(λ×sin θ) (7)

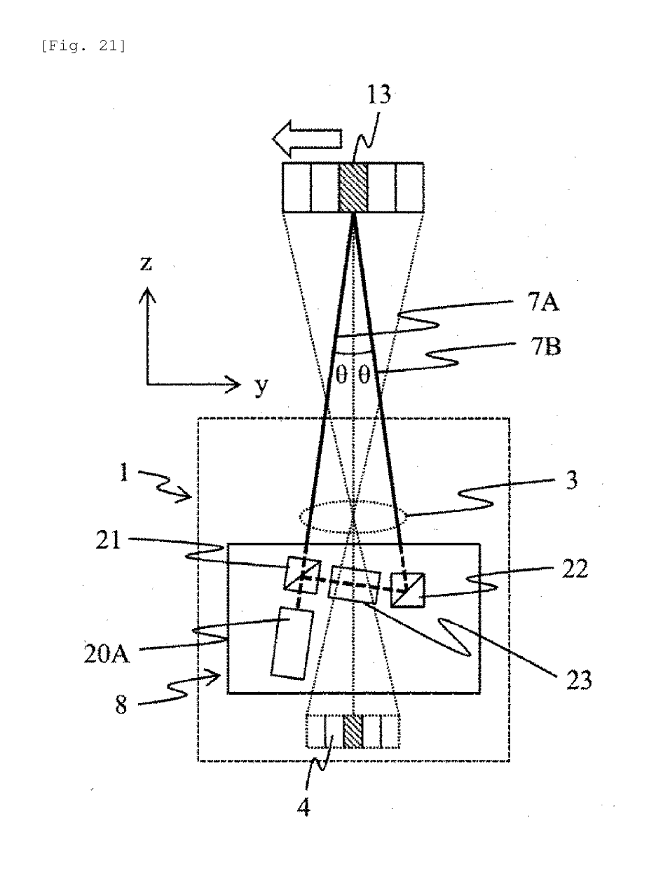

FIG. 20 illustrates a result which is obtained by performing FFT processing with respect to the light intensity change signal which is detected in the light receiving element 4. The frequency of the composite vibration is shifted from Δf in a case in which the image capturing target is stopped, by a value which is determined by the speed vo of the image capturing target. In this manner, it is possible to calculate the movement speed vo of the image capturing target by obtaining a change in composite frequency which occurs due to interferences of two lasers.

Meanwhile, in image capturing in the TDI camera 1, in order to accumulate charges by causing a charge transmission speed to be matched, a magnification M (=a/b) of the lens 3 is interposed between the speed vo of the image capturing target and a charge transmission speed vi of the TDI camera 1, and the following relational expression is satisfied.

vo=M×vi (8)

The speed vi with which the charge transmission speed matches is calculated from vo which is calculated in the above described method, and the magnification M which is obtained from a control position of the lens 3, by using the expression, and a driving charge transmission speed of the TDI camera 1 is controlled. In addition, the lasers which are arranged inside the light projection device 8 are not limited to the configuration illustrated in FIG. 16 when it is a configuration in which the light beams 7A and 7B with a frequency difference are radiated, and for example, as illustrated in FIG. 21, it may be a configuration in which light radiated from one laser 20A is divided into two light beams using a beam splitter 21 and a mirror 22, and a frequency difference is made in one light beam thereof by using a frequency shifter 23. In addition, in the above descriptions, the light beam 7B is set so as to have a higher frequency than the light beam 7A; however, a magnitude of the frequencies may be reversed, and a frequency of the light beam 7B may be set to be low. In that case, the frequency shift of positive and negative which is illustrated in the expressions (5), (6), and (7) is reversed.

By adopting the above described method, a relative movement speed is obtained from a captured image of the TDI camera 1, and the charge transmission speed of the TDI camera 1 is controlled so that sensitivity becomes constant at all times.

Subsequently, a method of detecting a defect from a captured image will be described.

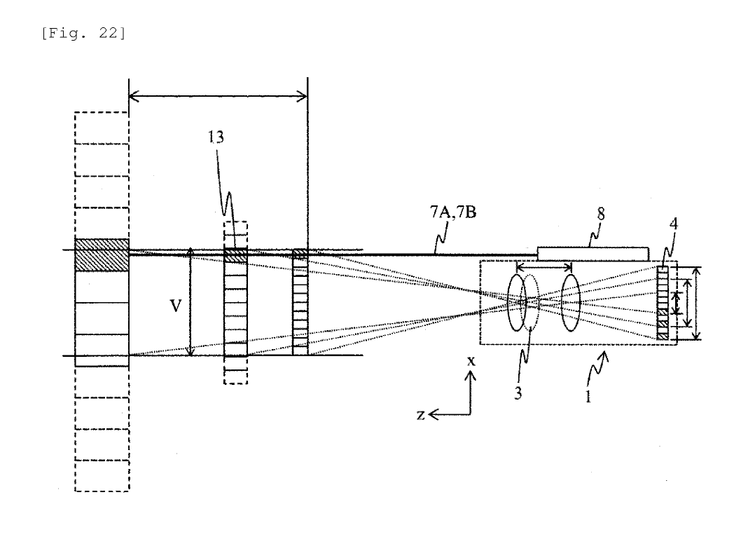

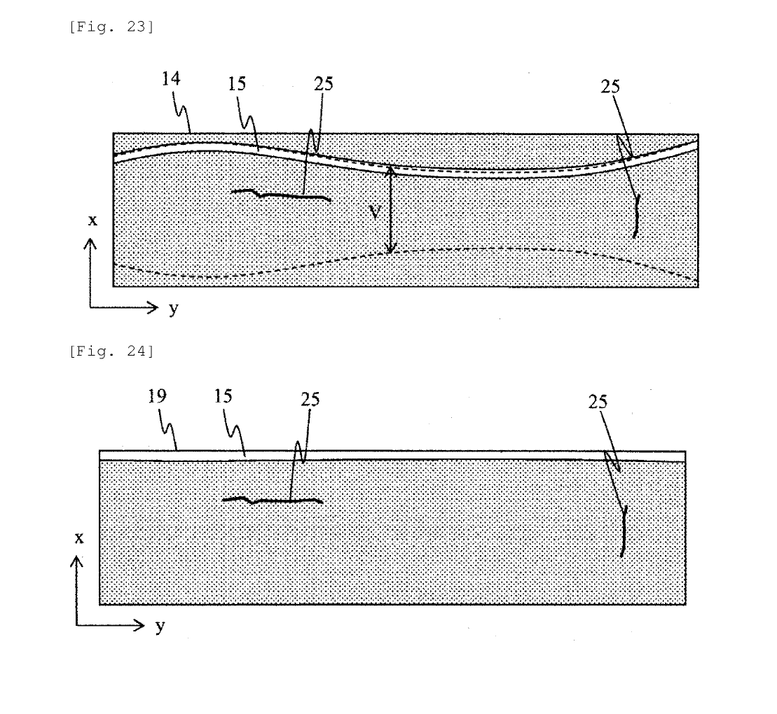

As illustrated in FIG. 22, in a case in which the lens 3 is controlled so as to be focused depending on a change in image capturing distance, since a magnification is different depending on an image capturing distance, a range of a visual field of an image capturing target is changed. Therefore, in step S112 in FIG. 4, a correction of a size of a visual field of a captured image is performed, and digital zooming is applied in order to make the size of the visual field constant. FIG. 23 illustrates a diagram which describes a digital zooming applying range in the TDI camera 1 and an image capturing target, and FIG. 24 illustrates the digital zooming range of a captured image which is illustrated in FIG. 22. A digital zooming width V becomes large at a position from which an image capturing distance is close, and becomes small at a position from which the image capturing distance is far, with respect to a captured image before applying the digital zooming. In addition, the number of pixels of the light receiving element 4 in the digital zooming applying range is determined from the digital zooming width V. The number of pixels m of the light receiving element 4 is calculated using the following expression (9), by using a width P of the light receiving element 4, the distance a between the lens 3 and an image capturing target at a time of image capturing, and the distance b from the lens 3 to the light receiving element 4.

m=(1/P)×V×(b/a) (9)

FIG. 24 illustrates an example of a captured image to which digital zooming is applied. At this time, an image processing result in which the emission line 15 which is changed according to an image capturing distance is located at a constant x-coordinate position is obtained. In addition, the emission line 15 may not be included in a digital zooming image 19. According to the above described method, the digital zooming image 19 is sent to S113, and an extracting process of a defect such as a crack is performed.

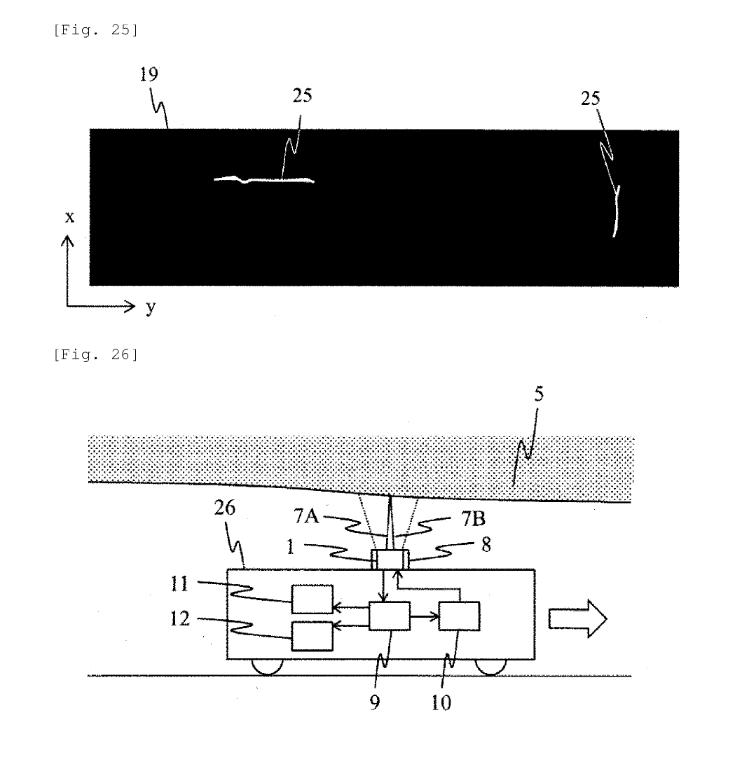

In the digital zooming image 19 which is illustrated in FIG. 24, a defect 25 such as a crack or a crevice is present. The crack or the crevice is captured as an image which is dark relative to the original surface pattern area of a structure. Therefore, for example, only the defect 25 which is captured as a dark image is extracted from the digital zooming image 19 by performing image processing such as binarization processing of luminance, and an output image illustrated in FIG. 25, or defect information data such as a position of the defect, or a length is obtained. In addition, another processing from which the same effect can be obtained may be used in the image processing in which a defective portion is extracted, and for example, boundary extracting processing, or the like, may be used. In addition, noise eliminating processing such as smoothing processing may be added as necessary, before or after the processing of extracting only the defective portion. In addition, regarding a relationship between a defect and luminance on the original surface of a structure, it is not necessary to determine that a defective portion is definitely a portion which is captured as a dark image, and for example, image processing such as binarization processing may be performed by causing the defective portion to be captured as a bright image with respect to the surface of the structure by using supplementary lighting, or the like, together. In addition, it may be processing in which pass or fail is determined depending on whether or not a defect goes beyond a predetermined reference value, by adding processing for determining whether or not there is a crevice portion as necessary, and performing sizing (calculating of length and width) processing of the defect, for example, according to a purpose of inspection and an inspection reference which are set.

According to the above described method, a defective portion is extracted from a captured image of the TDI camera 1.

Obtained defect information data is displayed on the display unit 11, or is stored in the storage unit 12 in step S114. Thereafter, whether or not image capturing of the entire inspection region is completed is determined in S113. In a case in which there is an uncaptured region, the inspection returns to S102, and a movement to the uncaptured region, and image capturing processing are performed. In a case in which image capturing in the entire region is completed, and there is no uncaptured region, the inspection proceeds to S114, and the inspection is completed.

According to the above described method, it is possible to inspect a defect on the surface of a structure with high accuracy in the middle of high speed moving. That is, it is possible to capture an image of the surface of a structure in the middle of high speed moving at a constant magnification and constant sensitivity, and inspect a defect on the surface of the structure with higher accuracy even in a driving speed on a business basis.

In addition, as illustrated in FIG. 26, the inspection apparatus may have a configuration in which a moving body 26 is added to the apparatus illustrated in FIG. 3, the TDI camera 1, the light projection device 8, the image processing unit 9, the control unit 10, the display unit 11, and the storage unit 12 are mounted on the moving body 26, and the moving body moves along the structure body 5 as the inspection target.

In addition, the invention is not limited to the above described embodiment, and various modification examples are included therein. For example, the above described embodiment has been described in detail in order to easily explain the invention, and does not definitely include the entire configuration which is described. In addition, it is possible to replace a part of configurations of a certain embodiment with a configuration of another embodiment, and it is also possible to add a configuration of another embodiment to a configuration of a certain embodiment. In addition, it is possible to perform an addition, a deletion, a replacement of another configuration with respect to a part of configurations of each embodiment.

### REFERENCE SIGNS LIST

1. TDI CAMERA

2. MEASURING POINT

3. LENS

4. LIGHT RECEIVING ELEMENT

5. STRUCTURE

6. IMAGE CAPTURING REGION

7A, 7B. LIGHT BEAM

8. LIGHT PROJECTION DEVICE

9. IMAGE PROCESSING UNIT

10. CONTROL UNIT

11. DISPLAY UNIT

12. STORAGE UNIT

13. RADIATING POINT

14. CAPTURED IMAGE

15. EMISSION LINE

16. CENTER LINE

17. CENTER AXIS

18. REFERENCE POSITION

19. DIGITAL ZOOMING IMAGE

20A, 20B. LASER

21. BEAM SPLITTER

22. MIRROR

23. FREQUENCY SHIFTER

25. DEFECT

26. MOVING BODY

S101. STEP OF STARTING INSPECTION

S102. STEP OF MOVING

S103. STEP OF IMAGE CAPTURING PROCESSING

S104. STEP OF EXTRACTING EMISSION LINE

S105. STEPS OF CALCULATING DISTANCE AND SPEED

106. DISTANCE DATA

107. SPEED DATA

S108. STEP OF DETERMINING DISTANCE MATCHING

S109. STEP OF CONTROLLING LENS POSITION

S110. STEP OF DETERMINING SPEED MATCHING

S111. STEP OF CONTROLLING CAMERA DRIVING SPEED

S112. STEP OF CORRECTING VISUAL FIELD

S113. STEP OF EXTRACTING DEFECT

S114. STEPS OF DISPLAYING CAPTURED IMAGE AND STORING CAPTURED IMAGE

S115. STEP OF DETERMINING COMPLETION OF INSPECTION

S116. STEP OF COMPLETING INSPECTION

1. A defect inspection apparatus of a structure comprising:
an image capturing machine which performs image capturing of a surface of a structure by moving along the surface of the structure;
a light projection device which radiates light to an image capturing region of the image capturing machine;
a first control unit which controls a lens position of the image capturing machine by using a distance to the surface of the structure which is obtained from an image capturing position of light captured in the image capturing machine; and
a second control unit which controls a transmission speed of a driving charge of the image capturing machine by using a movement speed relative to the structure which is obtained from a frequency of the light captured in the image capturing machine.

2. The defect inspection apparatus of the structure according to claim 1, further comprising:
an image processing unit which has a visual field correction function of a captured image.

3. The defect inspection apparatus of the structure according to claim 1,
wherein the relative movement speed is obtained by performing FFT processing with respect to a light intensity change signal which is captured in the image capturing machine.

4. A defect inspection method of a structure comprising:
a procedure of performing image capturing of a surface of a structure by moving along the surface of the structure;
a procedure of radiating light to an image capturing region;
a procedure of controlling a lens position of the image capturing machine by using a distance to the surface of the structure which is obtained from an image capturing position of light which is captured; and
a procedure of controlling a transmission speed of a driving charge of the image capturing machine by using a movement speed relative to the structure which is obtained from a frequency of the light captured in the image capturing machine.
